(19) United States
(12) Patent Application Publication
(10) Pub. No.: US 2024/0030846 A1
(43) Pub. Date: Jan. 25, 2024

(54) A/C D/C REGENERATOR

(71) Applicant: Brian Dougherty, Suisun City, CA (US)

(72) Inventor: Brian Dougherty, Suisun City, CA (US)

(21) Appl. No.: 18/369,803

(22) Filed: Sep. 18, 2023

Related U.S. Application Data
(60) Provisional application No. 63/389,920, filed on Jul. 17, 2022.

(51) Int. Cl. H02P 9/02; H02M 7/04

(52) U.S. Cl. CPC H02P 9/02; H02M 7/04

(57) ABSTRACT

The present invention relates to a power generator made of a plurality of automotive alternators. The generator comprises a plurality of alternators that convert alternating current to direct current, driving mechanism that turns rotor shaft of the plurality of alternators, and control mechanism that monitors and controls operations of the power generator. The generator produces voltage and amperage to run electronic devices off a 120V or 220V. All components of the generator are enclosed in a cylinder so that it could be mounted in a vehicle as an auxiliary power supplier or used as a standalone power generator.

### CROSS-REFERENCE TO RELATED APPLICATIONS

This application claims benefit to the provisional application U.S. 63/389,920 filed on Jul. 17, 2022, and is incorporated in its entirety.

### BACKGROUND OF THE INVENTION

An alternator turns mechanical energy into electrical energy. The generated electrical energy is alternating current (AC). An automotive alternator (hereinafter called “alternator”) converts the alternating current to direct current (DC) by rectifying it. The DC power activates a car's electrical systems and recharges a rechargeable battery. An automobile engine turns the alternator's rotor shaft providing the mechanical energy. However, the speed of an automobile engine varies during driving. The varying speed produces varying levels of electricity causing issues with electrical systems that require constant levels of electricity. A voltage regulator is used to even out the fluctuation of DC power so that constant DC power is provided to the electrical systems and the battery.

Heavy industrial or commercial vehicles require large capacity alternators because of higher electrical load requirements. The cost of ever larger vehicular alternators is not linear with larger power capacities. Larger capacity alternators are exponentially larger, heavier, and costlier than smaller capacity alternators. Bigger mechanical parts of the larger capacity alternators cause more friction and heat. Thicker gauge wires to carry larger current makes the mass and size of the alternator greater. In fact, heavy vehicles do not have alternators of such capacity, but instead draw significant power from their batteries during heavy electrical loads. This power draw increases the size of the batteries, increasing vehicle cost, weight, and operational cost. A frequent charge and discharge of the batteries shortens their operational life as well.

Thus, there is a need for a high-capacity alternator system that does not add disproportionate procurement cost or operational cost of putting a heavy burden on batteries. One such solution would be utilizing several cost-effective alternators operating in a tandem parallel connection as in the present invention. Such utilization of a plurality of alternators also provides fail-safe features of overcoming partial failure of some of the several alternators.

### SUMMARY OF THE INVENTION

In view of the foregoing background, the present invention offers an apparatus and system to provide electrical power to a wide range of systems.

Two electronic motors on both sides of the alternator pack drive the several alternators by turning the alternators' rotor shaft. The several alternators are electrically connected in tandem-parallel across a battery or a load. A regulator monitors the operation of each alternator and maintains comparable levels of voltage output by controlling the voltage regulator of each corresponding alternator. This regulator also controls the speed of the driving motors to maintain a steady stream of electrical power.

Failure of some of alternators or voltage regulators can be overcome by controlling the speed of the motors that drive the remaining functional alternators. Such a fault tolerant scheme is possible because this invention uses a plurality of cost-effective alternators. A programmable logic controller monitors and controls the operation of the system. The entire system is economically realized, reliably operated, and entirely enclosed in a cylinder. Such a configuration makes this invention to be used in a wide range of applications and locations.

Alternative embodiment of the invention is replacing the electronic motors with free spinning wheels. The wheels bolted onto the rotor shaft of the alternators are to provide the motion and torque to run the plurality of alternators. An external device that turns the wheel drives the alternators in this embodiment.

### BRIEF DESCRIPTION OF DRAWINGS

FIG. 1 is a schematic diagram showing components of AC/DC re-generator.

FIG. 2 is a block diagram depicting the layout of alternators, voltage regulator, and electronic motors.

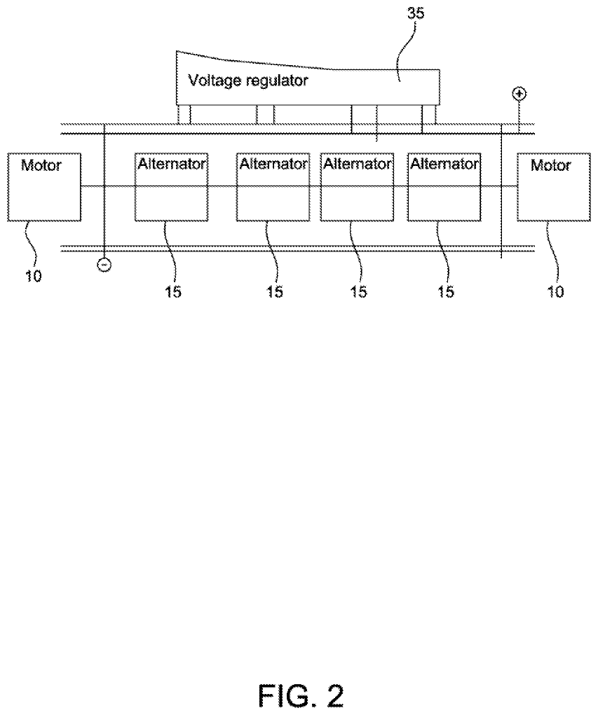

FIG. 3 shows an AC/DC re-generator housed in an enclosure.

FIG. 4 shows an AC/DC re-generator with free spinning wheels bolted onto the rotor shaft, replacing the electronic motors.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiment set forth herein. Rather, these embodiments are provided so that this disclosure will be thorough and complete, and will fully convey the scope of the invention to those skilled in the art.

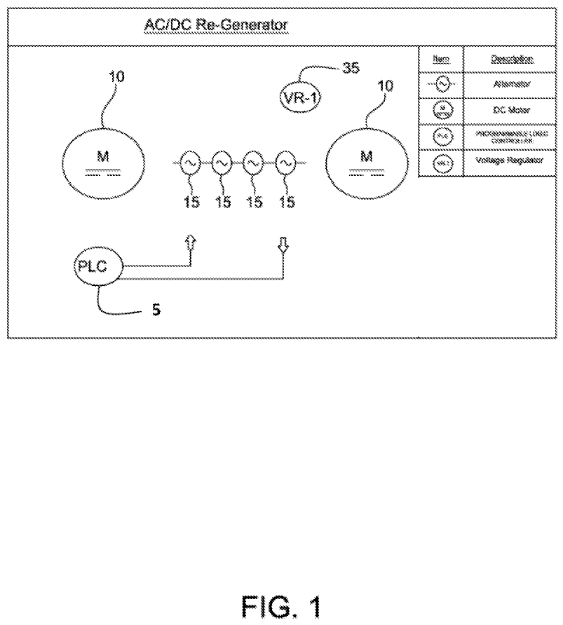

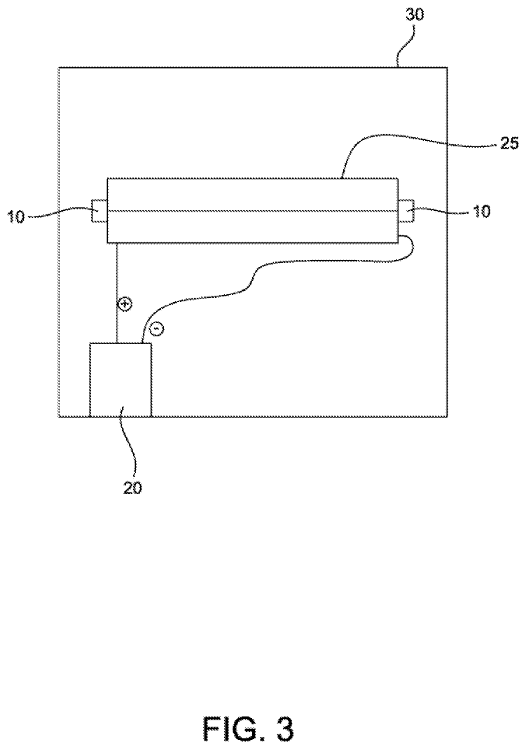

Using variable speed electronic motors that operate at 1000 RPM to 6000 RPM, the electronic motors power four multistage alternators 15 of FIG. 1. The electronic motors run off a 12V, 24V, or 120V power source 20 of FIG. 3. The generated direct current keeps batteries charged and/or produces enough voltage and amperage to run any electronic device off a 120V or 220V. The invention can also be used in electric vehicles to sustain amperage draw to the batteries while driving or “not driving but activating electrical system” depending on loads.

The device is made into a long cylinder 25 with a motor 10 on both ends mounted inside the box 30, along with a 12V battery and/or directly to a 120V power source 20. Inside the cylinder 25 of FIG. 3 are four alternator assemblies 15. An alternator comprises a starter, bearings, rectifier, and voltage regulator. The alternators are connected by the shaft using a porcelain spacer to not allow voltage runoff. This device can be used for electric vehicles and could be mounted in the trunk next to the batteries and connected straight to the batteries and ignition switch, causing the alternator to charge the batteries and to use variable speeds to accommodate the amp draw. The device can be a standalone unit that supplies a 120V to 220V output with the capability of meeting any load or amp draw with the variable speed of the alternator assemblies.

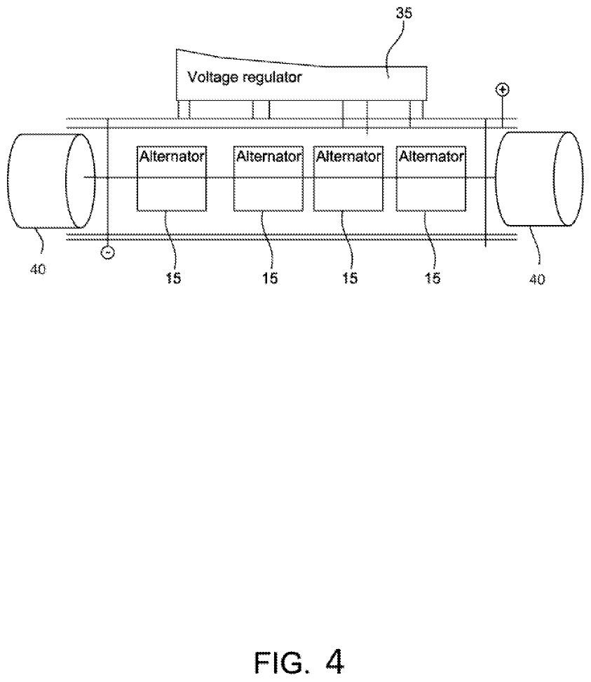

An alternative embodiment of the present invention is to replace the electronic motors with free spinning wheels 40 of FIG. 4. External mechanical forces are used to provide the motion and torque to run the alternator assemblies. The free spinning wheel 40 is connected to an external device that turns the wheels. This embodiment does not need built-in electronic motors and electric power source to drive the electronic motors. The generated power is proportional to the rotational force provided by the external device.

The programmable logic controller 5 of FIG. 1 is an electronic device that monitors and controls the overall operation of the device. It monitors the operations of alternators and regulators. It activates remedial measures when it detects anomaly on the alternators or the regulators. Unless the anomaly is catastrophic such as multiple component failures, the programmable logic controller 5 of FIG. 1 is capable of kickstarting fail-safe features of overcoming partial failure of some component.

All embodiments can keep a 12V battery fully charged during operation without impeding the output required to provide. This device provides auxiliary power to power electronic devices that have an occasional strong amperage draw. According to an embodiment, the box 30 of FIG. 3 is soundproof.

One skilled in the art, after being exposed to the teachings provided in the preceding descriptions and associated drawings, will likely conceive various modifications and alternative embodiments of the invention. Hence, it is important to note that the invention is not limited to the disclosed specific embodiments, and that modifications and alternative embodiments are intended to be encompassed within the scope of the appended claims.

Thus, the scope of the present disclosure is to be determined by the broadest permissible interpretation to the maximum extent allowed by law, of the following claims, and shall not be restricted or limited by the foregoing description.

1. An automotive alternator system comprising:
a plurality of alternators that convert alternating current to direct current;
a plurality of electronic motors that turns rotor shaft of said alternator;
free spinning wheels bolted onto the rotor shaft;
a voltage regulator;
a programmable logic controller; and
a cylinder that contains all said components.

2. The automotive alternator system according to claim 1, wherein the alternator comprises rotor, stator, rectifier, voltage regulator, and starter.

3. The automotive alternator system according to claim 1, wherein the electronic motors are positioned at both ends of said alternator pack.

4. The automotive alternator system according to claim 1, wherein the free spinning wheels are bolted onto the rotor shaft at both ends of said alternator pack.

5. The automotive alternator system according to claim 1 keeps batteries charged and/or produces voltage and amperage to run electronic device off a 120V or 220V.

6. The electronic motor of claim 3, wherein it operates at 1000 RPM to 6000 RPM.

7. The automotive alternator system according to claim 1, wherein a voltage regulator is used to even out the fluctuation of voltage output of each alternator.

8. The automotive alternator system according to claim 1, wherein a programmable logic controller monitors and controls operation of the system.

9. The automotive alternator system according to claim 1, wherein a plurality of alternators is connected by a shaft using a porcelain spacer in between.

10. The cylinder of claim 1 is soundproof.
